(19) United States
(12) Patent Application Publication
(10) Pub. No.: US 2008/0238903 A1
(43) Pub. Date: Oct. 2, 2008

(54) OSD controlling system and controlling method thereof

(75) Inventor: Jian-Feng Wang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/080,043

(22) Filed: Mar. 31, 2008

(30) Foreign Application Priority Data
Mar. 30, 2007 (CN) 200710073763.9

(51) Int. Cl. G06F 3/038

(52) U.S. Cl. 345/204

(57) ABSTRACT

An exemplary on-screen display (OSD) controlling system (1) includes an extended display identification data integrated circuit (EDID IC, 12) and a scalar integrated circuit (IC, 13) electrically connected to the EDID IC. The EDID IC includes a read-write part (122). The scalar IC includes a micro-controller unit (MCU, 131). The MCU is configured for processing data of the read-write part of the EDID IC. Because the scalar IC is connected to the EDID IC and can process the data stored in the read-write part, individualized information can be inputted by a user and displayed. Thus, the OSD controlling system can satisfy the demand for customization of an OSD.

### BACKGROUND

1. Field of the Invention

The present invention relates to an on-screen display (OSD) controlling system and an OSD controlling method, which enable a user to individualize information of an OSD.

2. General Background

In general, a monitor is a display device that is used with an apparatus such as a computer in order to show data generated by the computer. Most popular monitors can be classified as either CRT (Cathode Ray Tube) monitors or LCD (Liquid Crystal Display) monitors.

Some of these kinds of monitors have an OSD function for displaying information relating to adjusting of display characteristics of video signals transmitted from the computer, as well as information relating to the monitor itself. The OSD activated on the screen of the monitor can include a plurality of menus for altering information associated with a shape, a color, etc., of the display, or can include information about the video signals.

However, the displayed information of the OSD cannot be amended. For example, a user cannot record his or her name into the OSD as a identification mark, and cannot record other desired data such as a favorite maxim into the OSD. That is, the OSD cannot satisfy the demand for customization.

Therefore, a new OSD controlling system and method which can overcome the above-described shortcomings are desired.

### SUMMARY

In one preferred embodiment, an on-screen display (OSD) controlling system includes an extended display identification data integrated circuit (EDID IC) and a scalar integrated circuit (IC) electrically connected to the EDID IC. The EDID IC includes a read-write part. The scalar IC includes a micro-controller unit (MCU). The MCU is configured for processing data of the read-write part of the EDID IC.

Other novel features and advantages will become more apparent from the following detailed description when taken in conjunction with the accompanying drawings.

### BRIEF DESCRIPTION OF THE DRAWINGS

FIG. 1 is a block diagram of an OSD controlling system according to an exemplary embodiment of the present invention.

FIG. 2 is a flow chart summarizing an exemplary OSD controlling method utilizing the OSD controlling system of FIG. 1.

### DETAILED DESCRIPTION OF PREFERRED EMBODIMENTS

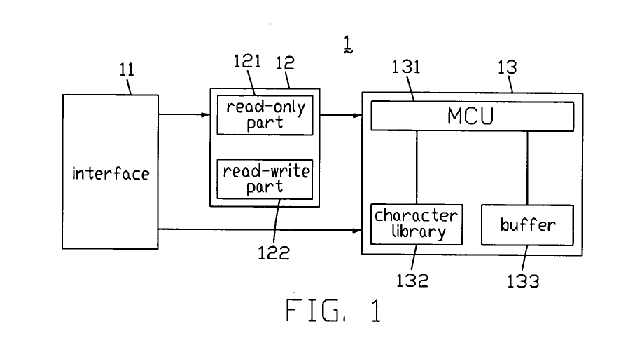

Referring to FIG. 1, an OSD controlling system 1 according to an exemplary embodiment of the present invention is shown. The OSD controlling system 1 includes an interface 11, an extended display identification data integrated circuit (EDID IC) 12 electrically connected with the interface 11, and a scalar integrated circuit (IC) 13 electrically connected with the interface 11 and the EDID IC 12 respectively. The EDID IC 12 includes a read-only part 121 and a read-write part 122. The scalar IC 13 includes a micro-controller unit (MCU) 131, a character library 132, and a buffer 133. The MCU 131 is electrically connected with the character library 132 and the buffer 133 respectively.

The interface 11 can be a video graphics array (VGA) interface, and is capable of communicating with various devices such as a graphics card of a personal computer through an Inter-Integrated Circuit (I²C) protocol. Alternatively, the interface 11 can be a digital visual interface (DVI).

The read-only part 121 of the EDID IC 12 can be a read-only memory, and is configured for storing company information, a time sequence, a maximum image size, color performance, languages, a convention (see below), and so on. All these items of information cannot be amended. The read-write part 122 can be a read-write memory. When a write operation function of the EDID IC 12 is not locked, a user can read and write the read-write part 122 via the interface 11; for example, by operating a mouse and/or a keyboard. When the write operation function of the EDID IC 12 is locked, the user cannot amend information stored in the read-write part 122; that is, the read-write part 122 is in a read-only state. The read-write part 122 includes an identifier. The identifier determines whether the OSD controlling system 1 provides an individualized display or not. That is, when the identifier is locked, individualized information is not displayed; and when the identifier is not locked, the individualized information is displayed.

The scalar IC 13 communicates with the EDID IC 12 through an I²C protocol. The MCU 131 can read and write the read-write part 122 of the EDID IC 12, and can further run and process data stored in the read-write part 122 of the EDID IC 12. The character library 132 stores characters and graphics which can be displayed in the OSD controlling system 1, in the form of codes. The buffer 133 stores function programs, and resources of characters and graphics which need to be displayed, such resources including locations, sizes, and colors of the characters and graphs. A transformation rule of the characters, graphics, codes, programs, and resources stored in the character library 132 and the buffer 133 is called a convention.

When the OSD controlling system 1 works, a user can input individualized information for the first time or re-input individualized information, and then determine whether to display the individualized information or not. The user can connect the interface 11 of the OSD controlling system 1 with a personal computer (not shown), transform the individualized information into corresponding codes according to the convention by utilizing appropriate software run in the personal computer, write the codes into the read-write part 122 of the EDID IC 12, and determine whether to lock the identifier (depending on whether the user wants the individualized information to be displayed or not).

When a display device (not shown) displays the individualized information, the scalar IC 13 reads the identifier of the EDID IC 12. If the identifier is not locked, the scalar IC 13 continues to read and run the codes of the read-write part 122, so as to display the individualized information on the display device. If the identifier is locked, the scalar IC 13 does not read the codes of the read-write part 122, such that the individualized information is not displayed on the display device.

In summary, because the interface 11 can read and write the read-write part 122, and the scalar IC 13 can communicate with the EDID IC 12 and process the data stored in the read-write part 122, the individualized information can be inputted by a user and displayed. Thus, the OSD controlling system 1 can satisfy the demand for customization of an OSD.

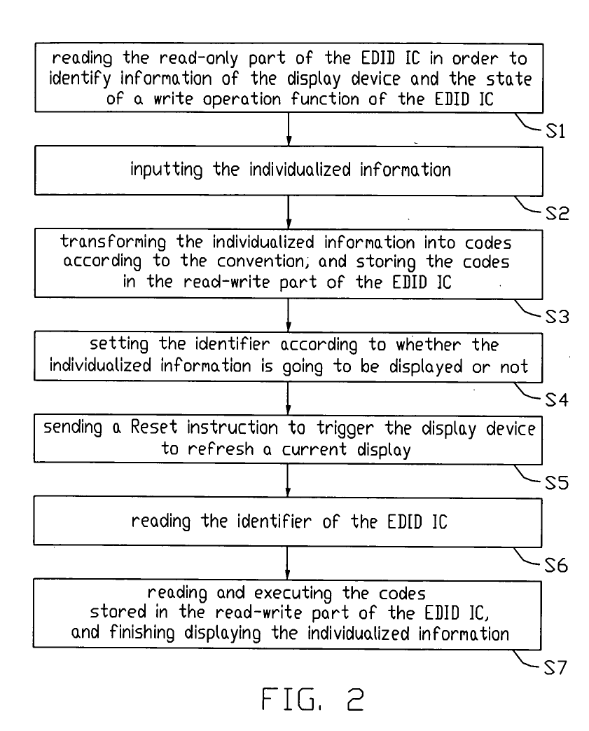

Referring to FIG. 2, an exemplary OSD controlling method utilizing the OSD controlling system 1 includes the following steps:

Step S1, reading the read-only part 121 of the EDID IC 12 in order to identify information of the display device and the state of a write operation function of the EDID IC 12.

The interface 11 is connected with an external device such as a personal computer, and communicates with the external device through an I²C protocol to obtain information required by the EDID IC 12, such as company information, a time sequence, a maximum image size, color performance, languages, and a convention, and the state of the write operation function of the EDID IC 12. If the write operation function of the EDID IC 12 is locked, individualized information cannot be inputted. If the write operation function of the EDID IC 12 is not locked, the subsequent steps are executed.

Step S2, inputting the individualized information.

The individualized information including for example characters, graphics, function programs, and resources of characters and graphics such as locations, sizes, and colors, is inputted through an input interface of the external device.

Step S3, transforming the individualized information into codes according to the convention, and storing the codes in the read-write part 122 of the EDID IC 12. The codes can be read and run by the scalar IC 13.

Step S4, setting the identifier according to whether the individualized information is going to be displayed or not. If yes, do not lock the identifier; and if not, lock the identifier.

Step S5, sending a Reset instruction to trigger the display device to refresh a current display. The Reset instruction can make the OSD controlling system 1 refresh the current display.

Step S6, reading the identifier of the EDID IC 12. If the identifier is locked, the individualized information is not displayed. If the identifier is not locked, the subsequent steps are executed to display the individualized information. The scalar IC 13 communicates with the EDID IC 12 through an I²C protocol.

Step S7, reading and executing the codes stored in the read-write part 122 of the EDID IC 12, and finishing displaying the individualized information.

It is to be further understood that even though numerous characteristics and advantages of the present embodiments have been set out in the foregoing description, together with details of the structures and functions of the embodiments, the disclosure is illustrative only; and that changes may be made in detail, especially in matters of arrangement of parts within the principles of the invention to the full extent indicated by the broad general meaning of the terms in which the appended claims are expressed.

What is claimed is:

1. An on-screen display (OSD) controlling system comprising:
an extended display identification data integrated circuit (EDID IC) comprising a read-write part; and
a scalar integrated circuit (IC) electrically connected to the EDID IC, the scalar IC comprising a micro-controller unit (MCU), the MCU configured for processing data of the read-write part of the EDID IC.

2. The OSD controlling system in claim 1, wherein the read-write part is a read-write memory.

3. The OSD controlling system in claim 2, further comprising an interface, the interface being electrically connected with the EDID IC.

4. The OSD controlling system in claim 3, wherein the interface supports an Inter-Integrated Circuit (I²C) protocol.

5. The OSD controlling system in claim 3, wherein the interface is also electrically connected with the scalar IC.

6. The OSD controlling system in claim 5, wherein the interface is one of a video graphics array (VGA) interface and a digital visual interface (DVI).

7. The OSD controlling system in claim 1, wherein the read-write part of the EDID IC comprises an identifier; wherein if the identifier is locked, the data of the read-write part cannot be processed; and if the identifier is not locked, the data of the read-write part can be processed.

8. The OSD controlling system in claim 1, wherein the scalar IC further comprises a character library, the character library storing characters and graphics supported by the OSD controlling system in the form of codes.

9. The OSD controlling system in claim 1, wherein the scalar IC further comprises a buffer, the buffer storing function programs and resources of characters and graphics.

10. The OSD controlling system in claim 1, wherein EDID IC communicates with the scalar IC through an Inter-Integrated Circuit (I²C) protocol.

11. The OSD controlling system in claim 1, wherein the EDID IC further comprises a read-only part.

12. An on-screen display (OSD) controlling method utilizing an OSD controlling system, the OSD controlling system comprising an extended display identification data integrated circuit (EDID IC) and a scalar integrated circuit (IC) electrically connected with the EDID IC, the EDID IC comprising a read-write part, the method comprising:
inputting information to be displayed;
transforming the inputted information into codes according to a convention, and storing the codes in the read-write part of the EDID IC; and
reading and executing the codes stored in the read-write part of the EDID IC, and thereby displaying the inputted information.

13. The OSD controlling method in claim 12, further comprising the following before inputting the information to be displayed:
reading the state of a write operation function of the EDID IC, wherein if the write operation function of the EDID IC is not locked, the method proceeds to inputting the information to be displayed.

14. The OSD controlling method in claim 13, wherein the EDID IC further comprises a read-only part, and the method further comprises reading the read-only part before reading the state of the write operation function of the EDID IC.

15. The OSD controlling method in claim 12, wherein the scalar IC comprises a character library and a buffer, the character library storing characters and graphics supported by the OSD controlling system in the form of codes, the buffer storing function programs and resources of the characters and the graphics.

16. The OSD controlling method in claim 15, wherein the convention is a transformation rule between the characters, the graphics, the programs, and the resources stored in the character library and the buffer and the codes.

17. The OSD controlling method in claim 12, wherein the read-write part of the EDID IC comprises an identifier, the identifier selectably having a locked state and an unlocked state.

18. The OSD controlling method in claim 12, further comprising the following between transforming the inputted information and reading and executing the codes:
setting the identifier according to whether the inputted information is going to be displayed or not, wherein if the inputted information is going to be displayed, the identifier is not locked, and if the inputted information is not going to be displayed, the identifier is not locked.

19. The OSD controlling method in claim 18, further comprising the following between setting the identifier and reading and executing the codes:
sending a Reset instruction to trigger a display device to refresh a display thereof.

20. The OSD controlling method in claim 19, further comprising the following between sending the Reset instruction and reading and executing the codes:
reading the identifier, and if the identifier is not locked, proceeding to reading and executing the codes.
